(19) United States
(12) Patent Application Publication
(10) Pub. No.: US 2005/0147789 A1
(43) Pub. Date: Jul. 7, 2005

(54) Method of joining a first component of a composite material to a second component of a different material and an automobile having a composite transmission tunnel bonded to metal floorplan panels

(75) Inventor: Michael Tate, Great Yarmouth (GB)

Correspondence Address: LUEDEKA, NEELY & GRAHAM, P.C., P O BOX 1871, KNOXVILLE, TN, 37901, US

(73) Assignee: Lotus Cars Limited

(21) Appl. No.: 11/035,578

(22) Filed: Jan. 14, 2005

(30) Foreign Application Priority Data
Feb. 14, 2000 (GB) 0003344.9

(51) Int. Cl. B32B 1/04; B32B 3/06; B32B 7/08; B32B 5/08; B32B 5/12

(52) U.S. Cl. 428/112; 156/92; 156/292; 156/331.7; 428/300.4

(57) ABSTRACT

The present invention relates to a method of joining a first component (10) of composite material composed of fibres set in a resin with a second component (11) of a different material; the first component (10) is provided with a flanged edge portion (12) and a layer of adhesive extends between said flanged edge portion (12) and the second component (11), the fibres in the flanged edge portion (12) extend into the remainder of the first component (10); and the smallest dimension of the surface area of the flanged portion (12) is no more than thirty-five times greater than the thickness of the layer of adhesive. The present invention also relates to an automobile having a transmission tunnel (10), wherein the transmission tunnel (10) is formed of a composite material composed of fibres set in a resin and the floorpan (11) comprises first and second metal panels (11) bonded one each to a spaced apart pair of longitudinal extending edges (12) of the transmission tunnel (10).

The present invention relates to a method of joining a composite component (i.e. a component composed of fibres set in a resin matrix) to a component of a different material. The present invention also relates to a motor vehicle having a composite transmission tunnel bonded to metal floorpan panels.

Some motor vehicles have an engine mounted forward of the passenger cabin which drives the rear wheels of the vehicle. In such an arrangement, a drive shaft is used to connect the engine with the rear wheels. The drive shaft typically runs along a transmission tunnel formed in the floor of the passenger cabin. The transmission tunnel is typically seen in the interior of the vehicle as a raised tunnel extending longitudinally along the vehicle. Sometimes, the gear box of the motor vehicle will extend at least into the front part of the transmission tunnel and sometimes the transmission tunnel will be used additionally for electrical cabling, conduits for hydraulic fluid (e.g. brake fluid), conduits for water and occasionally will allow passage of the exhaust pipe from the forwardly mounted engine to the rear of the vehicle.

The majority of motor vehicle bodies are formed from steel and the transmission tunnel is formed a feature in the floorpan panel or panels of the vehicle when it is/they are pressed. Other vehicles are made from aluminium panels and again the transmission tunnel is formed as a feature in the floor pan panel(s) when pressed. Some vehicles are formed out of composite components, e.g. formed of carbon or glass fibres set in an epoxy or polyurethane resin. When the components are moulded the transitional tunnel is a moulded feature in the floorpan moulding of the motor vehicle.

A transmission tunnel of a vehicle can be very important in carrying torsional loading on the vehicle, particularly if the vehicle does not have a chassis separate from the vehicle body and the vehicle body supports structural loads on the vehicle. It can therefore be preferred that the transmission tunnel is formed from a material different from the material of the surrounding bodywork. Also there is a manufacturing advantage in that a complex transmission tunnel shape can be formed without high tooling costs. However, this is difficult to achieve in practice due to thermal expansion. If the transmission tunnel is formed of one material and the panels of the surrounding floorpan are formed of different material, then when they are joined significant stresses can build up in the joints between the tunnel and the floorpan because of the difference in thermal expansion of the transmission tunnel from the surrounding floorpan sheets. This is especially the case when the exhaust pipe runs through the transmission tunnel, since the exhaust pipe can have a temperature of up to 700° C. and will directly heat the air within the transmission tunnel and the tunnel will therefore be hotter than the surrounding floor pan panels. Typically the design of the tunnel must allow for the interior surface of the tunnel to reach a temperature of 80° C.

According to a first aspect of the present invention there is provided a method of joining a first component of composite material composed of fibres set in a resin with a second component of a different material wherein:
the first and second components are bonded together by a layer of adhesive;
the first component is provided with a flanged edge portion and the layer of adhesive extends between the flanged edge portion of the first component and a facing surface of the second component;
the fibres in the flanged edge portion extend into the remainder of the first component; and
the flanged portion has a surface area with a smallest dimension which is no more than thirty-five times greater than the thickness of the layer of adhesive.

According to a second aspect of the invention there is provided an automobile having a transmission tunnel extending lengthwise of the vehicle set in a floorpan of the vehicle, wherein the transmission tunnel is formed of a composite material comprised of fibres set in a resin and the floorpan comprises first and second metal panels bonded one each to a spaced apart pair of longitudinally extending edges of the transmission tunnel.

The present invention will now be described with reference to the accompanying drawings in which:

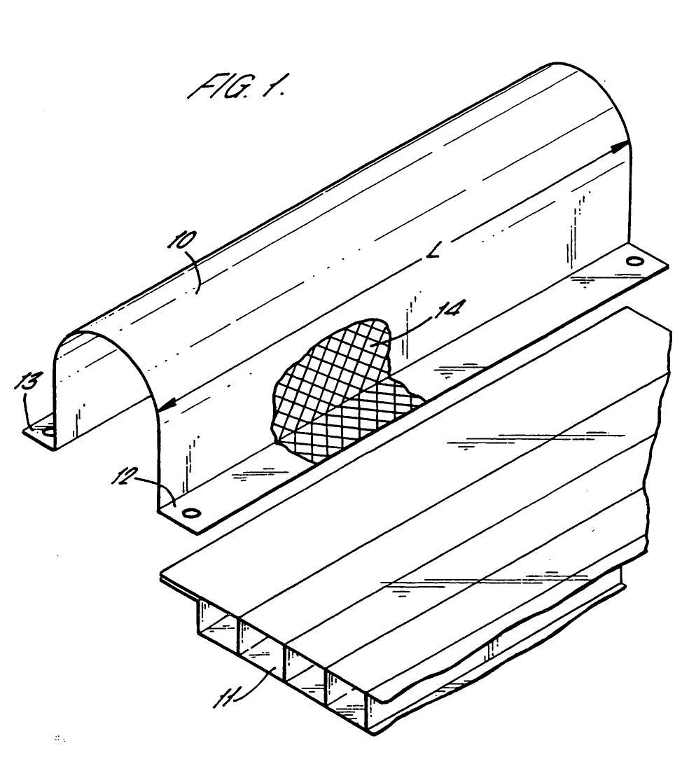

FIG. 1 is a schematic view showing a composite transmission tunnel and part of a floorpan panel of a

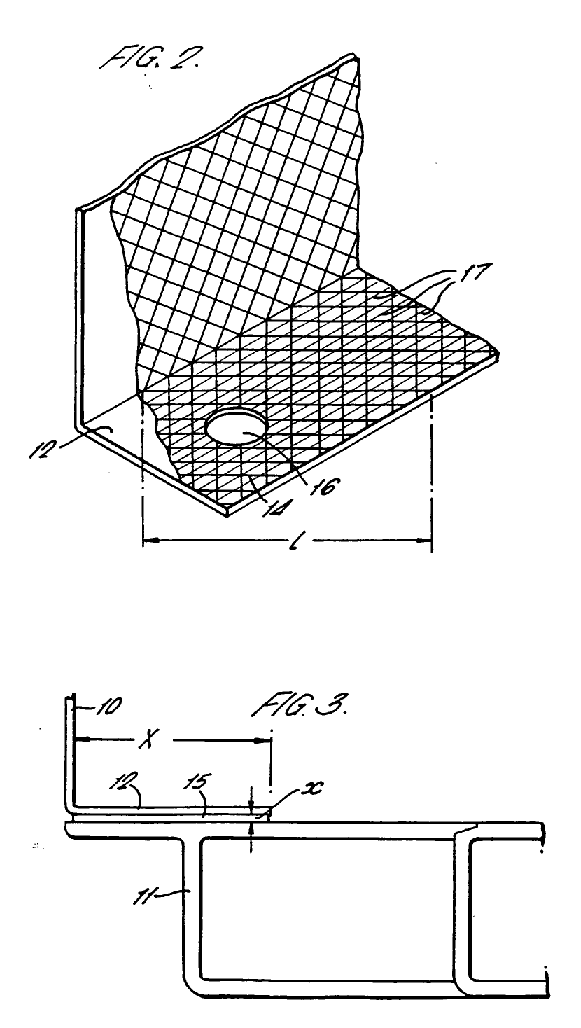

FIG. 2 shows a detailed view showing a small part of the transmission tunnel illustrated in FIG. 1;

FIG. 3 is a cross-sectional view, taking a cross-section through a joint according to the present invention;

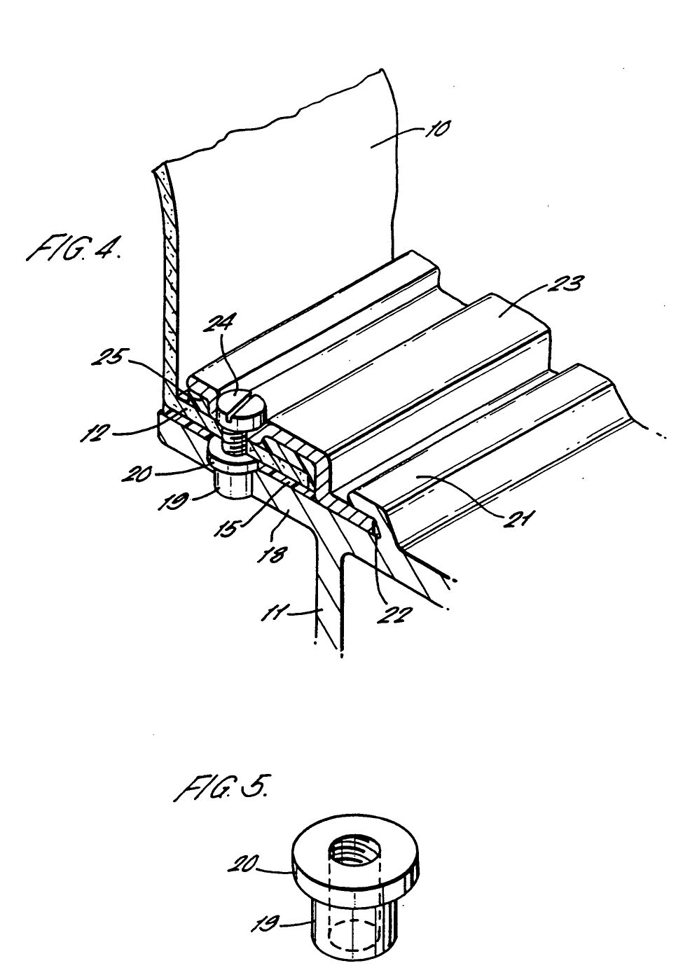

FIG. 4 is a detailed cross-sectional view of a joint according to the present invention; and

FIG. 5 is a component view of a component suitable for use in the formation of the joint of FIG. 4.

In FIG. 1 there can be seen a transmission tunnel 10 of an automobile (not shown) which is to be joined to the floor pan of the vehicle body. The floor pan is comprised of two matched panels. One floorpan panel 11 can be seen in FIG. 1.

The transmission tunnel 10 is a composite component comprising fibres set in an epoxy resin matrix. Throughout the arched central span of the component, the only fibres present in the resin are carbon fibres, but the transmission tunnel 10 has two flanges 12 and 13 in which carbon fibres and glass fibres are present set in the resin matrix. The reason for this will be described later.

Floorpan panel 11 and its matched panel (not shown) are made of aluminium. In particular they are extruded aluminium components.

The difficulty faced in creating a vehicle with a transmission tunnel formed largely of carbon fibres set in resin along with an aluminium floorpan panels results from the large difference in expansion coefficients of aluminium and carbon fibre composite material. Whilst aluminium has a large thermal expansion coefficient, carbon fibre has a negligible thermal expansion coefficient. The carbon fibre composite transmission tunnel has a significant length L, as can be seen in FIG. 1. In many applications, the exhaust of the engine will run along the transmission tunnel 10. The exhaust outer temperature can be around 700° C. Therefore, significant stresses can arise at the aluminium/carbon fibre interface due to different thermal expansions. However, it is very beneficial to make the transmission tunnel 10 from carbon fibre composite material, because of the good torsional rigidity of a carbon fibre transmission tunnel 10 which improves the torsional rigidity of the vehicle structure as a whole. Also carbon fibre composite material can be moulded into a complex shape without the need for expensive tooling.

It can be seen in FIG. 2 that in the transmission tunnel 10 the carbon fibres 14 are laid at a 45° angle with respect to the longitudinal axis of the transmission tunnel 10. The carbon fibres 14 are laid in layers with the fibres in each layer forming a mesh having fibres which are laid perpendicular to each other. All of the carbon fibres lie at 45° to a line running through them passing through transmission tunnel wall parallel to the longitudinal axis of the transmission tunnel 10.

The 45° angle layup of the carbon fibres gives the transmission tunnel 10 very good torsional stiffness. However, with the 45° layup the carbon fibres give moderate longitudinal stiffness and will allow the expansion or contraction of the tunnel 10 lengthwise (i.e. the dimension L) with changes in temperature.

In a motor vehicle body according to the present invention, the carbon fibre composite transmission tunnel 10 is bonded to the aluminium floor pan panel 11. In order to facilitate this, the carbon fibre composite tunnel 10 is provided with flanges, e.g. flange 12, which extend outwardly from the main span of the transmission tunnel 10. Indeed the flange 12 extends perpendicularly from the adjacent part of the main span of the transmission tunnel 10, as can be seen in FIG. 2. The length 1 of each carbon fibre 14 in the flange 12 is significantly shorter than the length L of the transmission tunnel as a whole. Because the length 1 is not large, the effect of the differing thermal expansion between the carbon fibre 14 and the aluminium of component 11 is not as significant as it would be if the transmission tunnel 10 was bonded to the aluminium of component 11 without the use of flanges.

In FIG. 3 it can be seen that the flange has a width dimension X which is roughly 40 mm. The flange 12 is bonded to the aluminium panel 11 by a layer of urethane adhesive. The thickness of the adhesive is controlled to between 1.2 to 1.5 mm. Urethane adhesive is used because it is more elastic than epoxy adhesive.

Provided that the dimension (X) is not greater than 35 (thirty five) times the thickness (x) of the adhesive layer, then the adhesive will be able to flex to allow for the different expansion between the carbon fibre panel 10 and the aluminium component 11. The adhesive layer 15 can accommodate the strain occasioned by the difference in rates of expansion provided that the layer 15 is thick enough in comparison with the width X of the flange.

In order to attach the carbon fibre transmission tunnel 10 to the extruded aluminium component 11 it is also beneficial to use bolts or other mechanical fasteners. These require the manufacture of apertures in the flange 12. One such aperture 16 can be seen in FIG. 2. The formation of apertures can cause difficulties if the fibres present in the flange are solely the carbon fibres arranged in mesh layers. The edges of the aperture 16 would not be stable and tearing and cracking could occur. To prevent this a series of glass fibres 17 run lengthwise of the carbon fibre tunnel 10 only in the flange portions 12 and 13. The glass fibres 17 expand with heat and the difference in expansion/contraction is therefore less than with the carbon fibres. The glass fibres are also less stiff than the carbon fibres, carbon fibres not being very elastic. The glass fibres give apertures in the flanges stability.

The apertures such as 16 can be used to receive threaded bolts which engage and fit with threaded bores in the facing surface of the aluminium panel 11. In FIG. 4 a preferred arrangement of an edge of the aluminium panel 11 can be seen. The edge of the aluminium panel 11 has a flange 18 which faces and extends parallel to the flange 12 when the transmission tunnel 10 has been bonded to the floor pan component 11. Preferably apertures are drilled in the flange portion 18 of the component 11 and then threaded inserts such as the threaded insert 19 shown in FIG. 5 are placed in the drilled apertures and fixed by adhesive. The threaded inserts 19 will have each have a head portion such as 20 and this head portion can be seen in FIG. 4 defining the depth of the layer of adhesive 15.

FIG. 4 shows a preferred arrangement of joint. The carbon fibre tunnel 10 has a flange 12 which is adhered to the flange 18 of the aluminium component 11, with the head portion 20 of the threaded insert 19 setting the depth of the adhesive layer 15. The extruded aluminium component 11 is also provided with a section 21 which defines a slot 22 into which is inserted an end part of a cover 23. The cover 23 will be of extruded aluminium. The cover 23 is bonded to the top surface of the flange 12 by an adhesive layer 25. The cover 23, the flange 12 and the flange 18 are all also connected together by a threaded bolt 24 which extends through an aperture drilled in the cover 23 and through a matching aperture in the flange 12 to matingly engage the threaded insert 19.

The present invention has been described above with reference to its use in facilitating the bonding together of a carbon fibre transmission tunnel 10 with an aluminium floor pan component 11. However, it should be appreciated that the invention is applicable wherever a component material component is bonded to any component of a different material. The example of a transmission tunnel is given by way of an example only, although it is a very pertinent example because the problems of differential thermal expansion are acute in the described application of the invention and the provision of a carbon fibre transmission tunnel is very beneficial in giving the structure of the automobile as a whole a torsional rigidity superior to that achieved with metal transmission tunnels of comparable dimensions. The present invention is particularly pertinent to the joining together of carbon fibre composites and aluminium since the materials have very different co-efficients of thermal expansion.

1. A method of joining a first component of composite material composed of carbon fibers set in a resin with a second component of a different material wherein:
the first and second components are bonded together by a layer of adhesive;
the first component is provided with a flanged edge portion and the layer of adhesive extends between the flanged edge portion of the first component and a facing surface of the second component;
the only carbon fibers in the flanged edge portion are carbon fibers which extend into the remainder of the first component;
the flanged edge portion has a surface area with a width which is no more than thirty-five times greater than the thickness of the layer of adhesive;
glass fibers are provided in the first component only in the flanged edge portion thereof to provide reinforcement and the glass fibers do not extend into the remainder of the first component; and
the glass fibers extend lengthwise along the flanged edge portion.

2. A method as claimed in claim 1 wherein the second component is composed of aluminium or an alloy of aluminium.

3. A method as claimed in claim 1 wherein the carbon fibers in the flanged edge portions are laid out in mesh layers having in each layer a first plurality of the carbon fibers at right angles to a second plurality of carbon fibers and wherein all of the carbon fibers are laid at 45° to the glass fibers, the glass fibers being laid out in layers of parallel extending glass fibers.

4. A method as claimed in claim 3 wherein apertures are formed in the flanged portion to permit the use of mechanical fasteners.

5. A method as claimed in claim 1 wherein the thickness of the adhesive layer is in the range 1.2 mm to 1.5 mm.

6. A method as claimed in claim 1 wherein the layer of adhesive is a layer of urethane adhesive.

7. A joint between a first component of composite material composed of fibers set in a resin and a second component of a different material made by a method as claimed in claim 1.

8. A structure comprising a first component of composite material composed of fibers set in a resin joined to a second component of a different material by a method as claimed in claim 1.

9. An automobile having a transmission tunnel extending lengthwise of the vehicle set in a floorpan of the vehicle, wherein:
the transmission tunnel is formed of a composite material composed of carbon fibres set in a resin and the floorpan comprises first and second metal panels bonded one each to a spaced apart pair of longitudinal extending edges of the transmission tunnel;
the pair of spaced apart longitudinally extending edges rare provided on a pair of spaced apart longitudinally extending flange portions of the transmission tunnel;
each flange portion is joined by a layer of adhesive to a facing surface of floorpan panel;
the transmission tunnel comprises carbon fibres which extend from the flange portions into a central span wall portion of the transmission tunnel; and
the transmission tunnel is provided with longitudinally extending glass fibres which extend along the length of the transmission tunnel only in the flange portions thereof.

10. An automobile as claimed in claim 9 wherein the width of each flanged portion is not more than thirty-five times the thickness of the adhesive layer.

11. An automobile as claimed in claim 9 or claim 10 wherein:
the carbon fibres are laid in mesh layers with in each mesh layer a first plurality of carbon fibres lying at right angles to a second plurality of carbon fibres; and
the carbon fibres each lie at 45° degrees to a line extending through the fibres running lengthwise along the transmission tunnel.

12. An automobile as claimed in any one of claims 9 to 11 wherein each flanged portion of the transmission tunnel has apertures which align with apertures in the facing surface of the respective floorpan panel to permit use of a mechanical fastener to supplement the bonding.

13. An automobile as claimed in claim 12, wherein:
the apertures in the floorpan panels are defined by threaded inserts secured in pre-made apertures in the floorpan panels; and
each threaded insert has a head portion wider than the pre-made aperture in which the threaded insert is secured; and
each head portion of each threaded insert acts as a spacer to define a desired depth of adhesive between the floorpan panel and the flanged portion of the transmission tunnel affixed thereto.

14. An automobile as claimed in claim 13 wherein the desired depth is in the range of 1.2 m to 1.5 mm.

15. An automobile as claimed in any one of claims 9 to 14 wherein the adhesive used to bond the floorpan panels to the transmission tunnel is a urethane adhesive.

16. An automobile as claimed in any one of claims 9 to 15 wherein the floorpan is made of aluminium or an alloy of aluminium.
